(19) United States
(12) Patent Application Publication
(10) Pub. No.: US 2020/0227937 A1
(43) Pub. Date: Jul. 16, 2020

(54) NOVEL INTELLIGENT CLIP CONTROL PANEL FOR EMERGENCY IGNITION POWER SUPPLIES

(71) Applicant: ShenZhen Domore Technology Ltd., Shenzhen (CN)

(72) Inventor: Jing Lu, shenzhen (CN)

(21) Appl. No.: 16/836,959

(22) Filed: Apr. 1, 2020

(51) Int. Cl. H02J 9/06; H02J 7/00; B60R 16/033; F02P 9/00

(52) U.S. Cl. CPC H02J 9/06; H02J 7/0045; F02P 9/00; B60R 16/033; H02J 7/0047

(57) ABSTRACT

A novel intelligent clip control panel for emergency ignition power supplies includes a relay not provided with a shell. At least one relay is installed on a circuit board and has a contact including a first junction, a second junction, a third junction and a fourth junction which are respectively connected to other circuits on the circuit board. According to the invention, the relay having a shell removed is directly installed on the circuit board of the intelligent clip control panel, so that the problem that the contact of the relay may be fused on a plastic shell and cannot restore is solved, and the relay is effectively prevented from being out of operation.

### BACKGROUND OF THE INVENTION

### 1. Technical Field

The invention relates to the field of car rescue, in particular to a novel intelligent clip control panel for emergency ignition power supplies.

### 2. Description of Related Art

The relays in existing connecting wire clips of emergency power supplies are standard and universal parts which are installed as they are delivered. The pursuit of a small size of commercial relays leads to an inherent disadvantage that movable contacts may adhere to plastic shells at a high temperature and cannot be disconnected, in this case, the batteries of the emergency power supplies will be charged for a long time, and consequentially, the batteries will swell, burn out, and catch fire.

Existing intelligent clip control panels for emergency ignition power supplies comprise at least one relay which will generate excessive heat when working under a large current, and at this moment, the contact of the relay will be fused on the plastic shell next to the edge of the relay and cannot restore, thus resulting in a product failure.

### BRIEF SUMMARY OF THE INVENTION

The primary objective of the invention is to provide a novel intelligent clip control panel for emergency ignition power supplies to solve the problem that a contact of a relay in an intelligent clip control panel in the related art may be fused on a plastic shell next to the edge of the relay and cannot restore, thus resulting in a product failure.

To fulfill the above-mentioned objective, the invention provides a relay not provided with a shell. At least one relay is installed on a circuit board and has a contact including a first junction, a second junction, a third junction and a fourth junction which are connected to other circuits on the circuit board.

The invention further provides an intelligent clip control panel connected to an emergency power supply. The intelligent clip control panel comprises the relay and has one end connected to a first ignition clip through a connecting wire and the other end connected to a connecting port through a connecting wire, and the connecting port is inserted into an interface of the emergency power supply.

Preferably, the intelligent clip control panel further comprises a drive circuit and a microcontroller, the first junction is connected to a positive pole or a negative pole of the first ignition clip, the second junction is connected to a positive pole or a negative pole of the connecting port, the third junction is connected to a first path of the drive circuit, and the fourth junction is connected to a grounding path of the microcontroller.

Preferably, a second path of the drive circuit is connected to a first path of the microcontroller.

Preferably, the connecting port includes a first connecting port and a second connecting port, wherein the first connecting port is connected to a positive pole or a negative pole of the emergency power supply and is connected to a second path of the microcontroller through a current-limiting resistor, and the second connecting port is connected to the relay.

Preferably, the intelligent clip control panel further comprises an LED indicator light connected to a third path of the microcontroller.

Preferably, the intelligent clip control panel further comprises a buzzer connected to a fourth path of the microcontroller.

Preferably, the intelligent clip control panel further comprises a detection circuit having one end connected to the microcontroller and the other end connected to the relay.

The invention further provides an emergency power supply connector which comprises the intelligent clip control panel, a first ignition clip, a second ignition clip, and a connecting port and is used for connecting a car battery to an emergency power supply.

Preferably, the first ignition clip and the second ignition clip are connected to the car battery in a manner that poles of the first ignition clip and the second ignition clip correspond to poles of the car battery.

The invention has the following beneficial effects: the intelligent clip control panel comprises the relay without the shell; and the relay having the shell removed is directly installed on the circuit board of the intelligent clip control panel, so that the problem that the contact of the relay may be fused on a plastic shell next to the edge of the relay and cannot restore when the relay is electrified for use is solved, the relay is effectively prevented from being out of operation, and the relay and other electronic parts are protected.

### BRIEF DESCRIPTION OF THE SEVERAL VIEWS OF THE DRAWINGS

For the sake of a clearer explanation of the technical solutions of the embodiments of the invention or the prior art, the accompanying drawings required for the description of the embodiments or the prior art are briefly introduced below. Clearly, the drawings in the following description are only used for illustrating certain embodiments of the invention, and those ordinarily skilled in the art can acquire other drawings according to the structures shown in following ones without creative labor.

FIG. 1 is a connection diagram of a relay and other parts in an embodiment of the invention;

FIG. 2 is a structural diagram of an intelligent clip control panel in an embodiment of the invention;

FIG. 3 is a circuit diagram of the intelligent clip control panel in the embodiment of the invention;

FIG. 4 is a structural diagram of an emergency power supply connector in an embodiment of the invention;

FIG. 5 is a structural diagram of an emergency power supply and the emergency power supply connector in an embodiment of the invention.

Reference Signs:

1, intelligent clip control panel; 11, relay; 12, drive circuit; 13, microcontroller, 14, detection circuit; 15, LED indicator light; 16, buzzer, 2, first ignition clip; 3, second ignition clip; 4, emergency power supply; 5, connecting port; 51, first connecting port; 52, second connecting port; 6, connecting wire.

The implementations, functional characteristics, and advantages of the invention are further explained below with reference to the embodiments and accompanying drawings.

### DETAILED DESCRIPTION OF THE INVENTION

The technical solutions of the embodiments of the invention are explicitly and thoroughly described below in combination with the accompanying drawings of these embodiments. Clearly, the embodiments in the following description are only illustrative ones, and are not all possible ones of the invention. On the basis of these illustrative embodiments, all other embodiments obtained by those ordinarily skilled in the art without creative labor should also fall within the protection scope of the invention.

It should be noted that all directional indications (such as upper, lower, left, right, front and rear) in the embodiments of the invention are only used to explain relative positional relations and movements of parts at a specific posture (as shown in the drawings), and if the specific posture changes, the directional indications will change accordingly.

Furthermore, the descriptions such as “first” and “second” in the invention are only for the purpose of description, and are not used to indicate or hint relative importance or to implicitly indicate the number of the technical features indicated. Thus, the features defined by “first” and “second” may explicitly or implicitly include at least one of the features. Unless otherwise explicitly and particularly defined, “a plurality of” in the description of the invention means at least two, such as two and three.

Unless otherwise explicitly specified and defined, the terms such as “connect” and “fix” should be understood generally in the invention. For instance, “connect” may refer to fixed connection, detachable connection or integral connection, or mechanical connection or electrical connection, or direct connection or indirect connection via a medium, or internal communication or interaction of two components, unless otherwise defined. Those ordinarily skilled in the art can understand the specific meanings of the terms mentioned above in the invention as the case may be.

Furthermore, those ordinarily skilled in the art can combine the technical solutions of the embodiments of the invention. A contradictory or unachievable combination of the technical solutions should be considered as nonexistent and should not fall within the protection scope of the invention.

### Embodiment 1

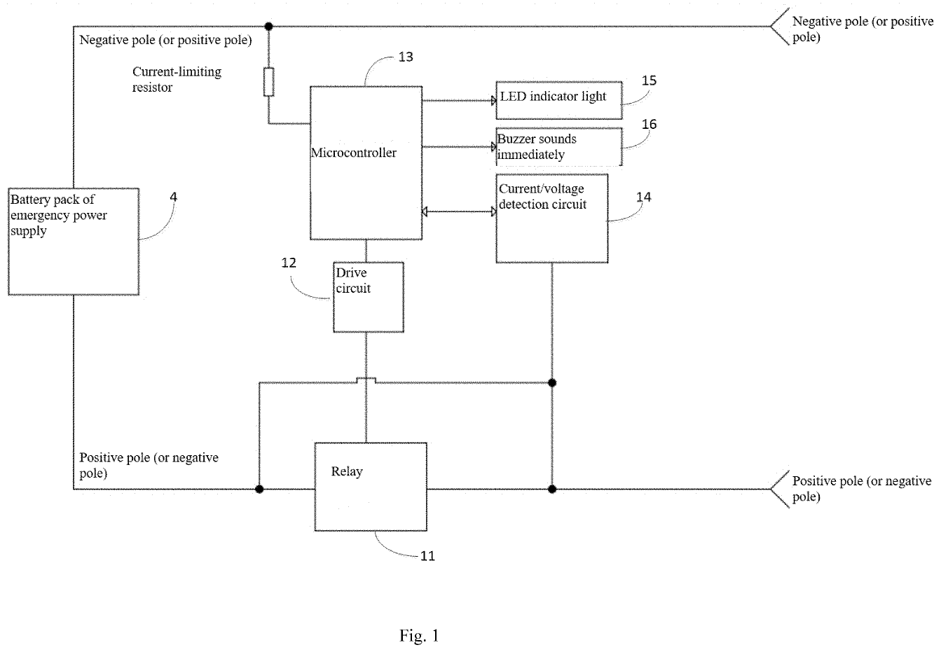

Referring to FIG. 1 to FIG. 3, the invention provides a relay 11 which is not provided with a shell. At least one relay is installed on a circuit board, and a contact of the relay 11 includes a first junction, a second junction, a third junction, and a fourth junction which are respectively connected to other circuits on the circuit board.

According to the invention, the relay 11 having the shell removed is directly installed on the circuit board of an intelligent clip control panel, so that the problem that the contact of the relay 11 may be fused on a plastic shell next to the relay and cannot restore when the relay 11 is electrified for use is solved, the relay 11 is effectively prevented from being out of operation, and both the relay 11 and other electronic parts are protected. Understandably, in other embodiments, the shell may be removed from the relay 11 and then be installed on the circuit board to protect the relay 11 and other electronic parts.

### Embodiment 2

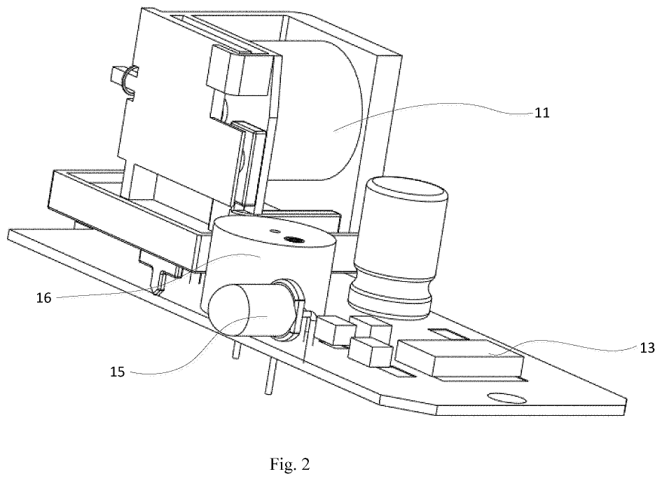

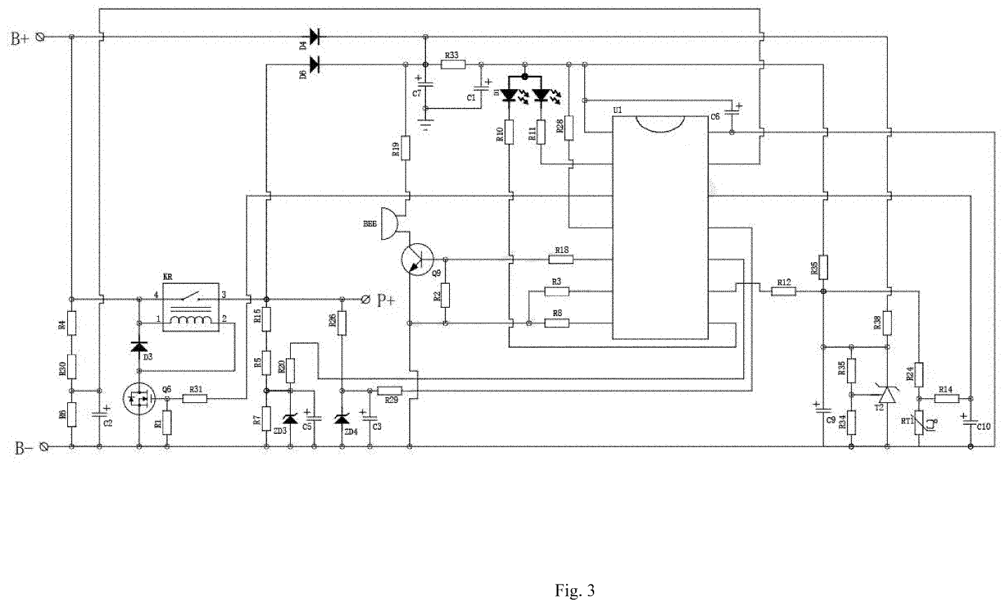

Referring to FIG. 2 and FIG. 3, the invention further provides an intelligent clip control panel 1 connected to an emergency power supply 4. The intelligent clip control panel 1 comprises the relay 11 and has one end connected to a first ignition clip 2 through a connecting wire and the other end connected to a connecting port through a connecting wire, and the connecting port is inserted into an interface of the emergency power supply 4.

In this embodiment, the relay 11 is installed in the intelligent clip control panel 1 which is connected to an emergency power supply connector, and the emergency power supply 4 is connected to a car battery through the emergency power supply connector to be charged, wherein one end of the intelligent clip control panel 1 is connected, through the connecting wire, to the first ignition clip 2 which is clamped on a positive pole or a negative pole of the car battery, and the car battery charges the emergency power supply 4 through the emergency power supply 4 connector. The shell disassembled from the relay 11 is installed in the intelligent clip control panel 1 to protect the intelligent clip control panel 1 and the emergency power supply 4 when the car battery charges the emergency power supply 4.

Referring to FIG. 3 again, the intelligent clip control panel 1 further comprises a drive circuit 12 and a microcontroller 13, the first junction is connected to a positive pole or a negative pole of the first ignition clip 2, the second junction is connected to a positive pole or a negative pole of the connecting port 5, the third junction is connected to a first path of the drive circuit 12, and the fourth junction is connected to a grounding path of the microcontroller 13.

Wherein, the first junction is directly connected to the positive pole or the negative pole of the first ignition clip 2, and the second junction is connected to a first path of the emergency power supply 4 through a field-effect transistor Q6. Wherein, the first path may be the connecting port 5 of the emergency power supply 4, the third junction is directly connected to the drive circuit 12, and the fourth junction is connected to the grounding path of the microcontroller 13 through a diode D4 and a capacitor C7 and is also connected to the drive circuit 12 through a diode D6. After the shell of the relay 11 is removed, even if the relay 11 generates a high temperature under a large current, the junctions can be effectively prevented from being fused and bonded on the shell and can be timely disconnected, so that the emergency power supply 4 can be timely disconnected from the connecting port.

Referring to FIG. 1 again, a second path of the drive circuit 12 is connected to a first path of the microcontroller 13. Wherein, the drive circuit 12 transmits a circuit signal to the microcontroller 13 to fulfill on-off control. In this embodiment, the drive circuit 12 and the microcontroller 13 are arranged on the same circuit board, and the second path of the drive circuit 12 is connected to the first path of the microcontroller 13, so that the microcontroller 13 outputs a control signal to the drive circuit 12 according to a received voltage signal and a received current signal to control on-off of the relay 11.

Furthermore, the connecting port 5 includes a first connecting port 51 and a second connecting port 52, wherein the first connecting port 51 is connected to a positive pole or a negative pole of the emergency power supply 4 and is connected to a second path of the microcontroller 13 through a current-limiting resistor, and the second connecting port 52 is connected to the relay 11. In this embodiment, the second path of the microcontroller 13 may be a power path, and in order to prevent the microcontroller 13 from being burned out by excessive currents, the current-limiting resistor is connected to the second path of the microcontroller 13 to achieve voltage division and current limiting for the current transmission of the microcontroller 13 in the current transmission process, so that the microcontroller 13 is protected against burnout.

Referring to FIG. 1 and FIG. 3, the intelligent clip control panel 1 further comprises LED indicator lights 15 which are connected to a third path of the microcontroller 13. In this embodiment, the LED indicator lights 15 used for showing a work state are configured, wherein a green LED indicator light 15 lights up when the state is normal, a red LED indicator light 15 lights up when the state is abnormal, and the LED indicator lights 15 are connected to the third path of the microcontroller 13 respectively through a resistor R10 and a resistor R11, the third path includes a plurality of pins connected to different LED indicator lights 15, and this embodiment has no limitation in this aspect.

Furthermore, the intelligent clip control panel 1 further comprises a buzzer 16 connected to a fourth path of the microcontroller 13. Wherein, the buzzer 16 is connected to the fourth path of the microcontroller 13 through a field-effect transistor Q9 and a resistor R18, and the microcontroller 13 alarms when an error state arises.

Referring to FIG. 1 again, the intelligent clip control panel 1 further comprises a detection circuit 14 having one end connected to the microcontroller 13 and the other end connected to the relay 11. The detection circuit 14 detects the current signal transmitted from the microcontroller 13, automatically detects the output current of the car battery, and automatically cuts off the circuits when currents and/or voltages are excessively high or excessively low to protect the circuits.

The intelligent clip control panel 1 in this embodiment can automatically detect the work state of an emergency start power supply of a car and will automatically cut off the circuits instantly to give a sound-light alarm when it is discovered that the circuits are reversed or the positive and negative ignition clips are short-circuited due to contact, thus fulfilling a protection effect.

### Embodiment 3

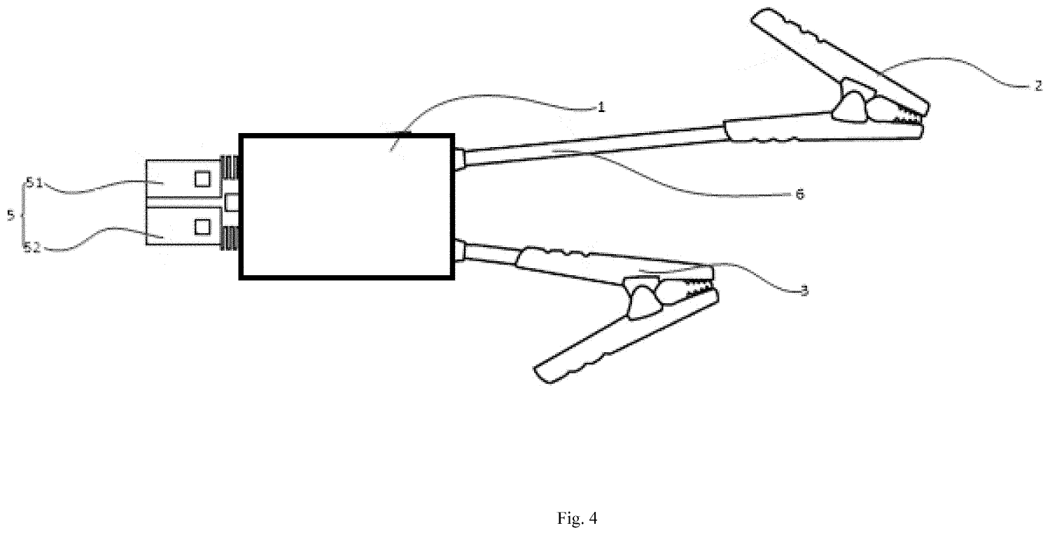

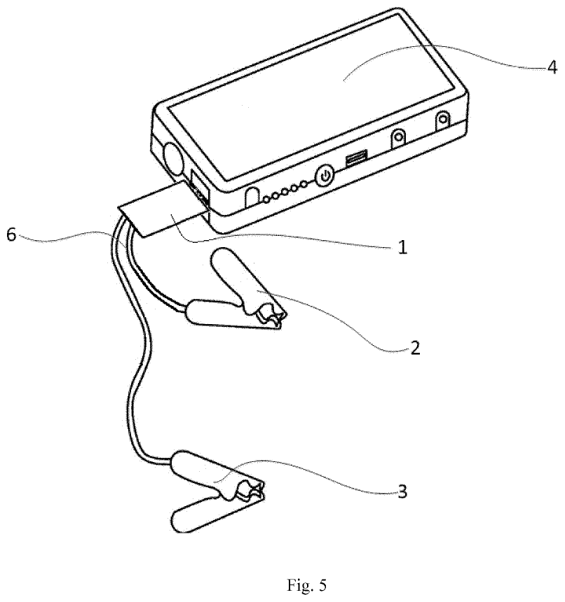

Referring to FIG. 4 and FIG. 5, the invention further provides an emergency power supply connector which comprises the intelligent clip control panel 1, a first ignition clip 2, a second ignition clip 3, and a connecting port 5 and is used for connecting a car battery to an emergency power supply 4. Understandably, the emergency power supply connector further comprises the connecting port 5 inserted into the emergency power supply 4, and the intelligent clip control panel 1 is connected to the emergency power supply 4 through the connecting port 5 and fulfills stable charging of the emergency power supply 4 through the first ignition clip 2 and the second ignition clip 3. The first ignition clip 2 and the second ignition clip 3 are connected to the car battery in a manner that poles of the first ignition clip 2 and the second ignition clip 3 correspond to poles of the car battery.

Wherein, the emergency power supply connector is an emergency power supply ignition connector. The intelligent clip control panel 1 can automatically detect the work state of an emergency start power supply of a car, will automatically cut off circuits instantly when it is discovered that the circuits are reversed or the positive and negative battery clips are short-circuited due to contact, can automatically and continuously detect a voltage change of the car battery before and after ignition through the detection circuit 14, and can automatically cut off the circuits to give a sound-light alarm through the LED indicator light 15 and the buzzer 16 when detecting that a voltage of the car after the ignition is higher than a voltage of the car before the ignition, thus protecting the emergency power supply 4. The implementation of the emergency power supply connector in this embodiment is consistent with that of the intelligent clip control panel 1 and thus will no longer be repeated herein.

The aforesaid embodiments are only preferred ones of the invention, and are not intended to limit the patent scope of invention. All equivalent structural transformations made on the basis of the concept of the invention according to the contents of the specification and the drawings of the invention, or direct or indirect applications to other related technical fields should also fall within the patent protection scope of invention.

What is claimed is:

1. A relay, being not provided with a shell, wherein at least one relay is installed on a circuit board and has a contact including a first junction, a second junction, a third junction and a fourth junction which are connected to other circuits on the circuit board.

2. An intelligent clip control panel, being connected to an emergency power supply, comprising the relay according to claim 1, and having an end connected to a first ignition clip through a connecting wire and an end connected to a connecting port through a connecting wire, wherein the connecting port is inserted into an interface of the emergency power supply.

3. The intelligent clip control panel according to claim 2, further comprising a drive circuit and a microcontroller, wherein the first junction is connected to a positive pole or a negative pole of the first ignition clip, the second junction is connected to a positive pole or a negative pole of the connecting port, the third junction is connected to a first path of the drive circuit, and the fourth junction is connected to a grounding path of the microcontroller.

4. The intelligent clip control panel according to claim 2, wherein a second path of a drive circuit is connected to a first path of a microcontroller.

5. The intelligent clip control panel according to claim 2, wherein the connecting port includes a first connecting port and a second connecting port, wherein the first connecting port is connected to a positive pole or a negative pole of the emergency power supply and is connected to a second path of a microcontroller through a current-limiting resistor, and the second connecting port is connected to the relay.

6. The intelligent clip control panel according to claim 2, further comprising an LED indicator light connected to a third path of a microcontroller.

7. The intelligent clip control panel according to claim 2, further comprising a buzzer connected to a fourth path of a microcontroller.

8. The intelligent clip control panel according to claim 2, further comprising a detection circuit having an end connected to a microcontroller and an end connected to the relay.

9. An emergency power supply connector, comprising the intelligent clip control panel according to claim 2, a first ignition clip, a second ignition clip and a connecting port, and being used for connecting a car battery to an emergency power supply.

10. An emergency power supply connector, comprising the intelligent clip control panel according to claim 3, a first ignition clip, a second ignition clip and a connecting port, and being used for connecting a car battery to an emergency power supply.

11. An emergency power supply connector, comprising the intelligent clip control panel according to claim 4, a first ignition clip, a second ignition clip and a connecting port, and being used for connecting a car battery to an emergency power supply.

12. An emergency power supply connector, comprising the intelligent clip control panel according to claim 5, a first ignition clip, a second ignition clip and a connecting port, and being used for connecting a car battery to an emergency power supply.

13. An emergency power supply connector, comprising the intelligent clip control panel according to claim 6, a first ignition clip, a second ignition clip and a connecting port, and being used for connecting a car battery to an emergency power supply.

14. An emergency power supply connector, comprising the intelligent clip control panel according to claim 7, a first ignition clip, a second ignition clip and a connecting port, and being used for connecting a car battery to an emergency power supply.

15. An emergency power supply connector, comprising the intelligent clip control panel according to claim 8, a first ignition clip, a second ignition clip and a connecting port, and being used for connecting a car battery to an emergency power supply.

16. The emergency power supply connector according to claim 9, wherein the first ignition clip and the second ignition clip are connected to the car battery in a manner that poles of the first ignition clip and the second ignition clip correspond to poles of the car battery.
